(19) United States
(12) Patent Application Publication
(10) Pub. No.: US 2004/0043800 A1
(43) Pub. Date: Mar. 4, 2004

(54) Mobile telephone device

(75) Inventor: Toshikatsu Hosoi, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/649,686

(22) Filed: Aug. 28, 2003

(30) Foreign Application Priority Data
Sep. 2, 2002 (JP) 256545/2002

(51) Int. Cl. H04M 1/00

(52) U.S. Cl. 455/575.1; 455/566

(57) ABSTRACT

Power saving means is provided for personal digital assistants by lowering an operating clock for a display and accessing a memory with a low clock via a bus.

A CPU 1 and a display controller 8 share a RAM 3 via a bus in a mobile telephone device. A continuation of an uncontrolled state during a predetermined period initiates an interruption processing which changes an operating clock for the CPU 1 from a normal clock to a peripheral clock of a low speed for a display 10, resulting in power saving in the CPU 1 during the time that any processing is not performed, while ordinarily refreshing the images on the display 10 enables normal images to be displayed on the display 10.

### BACKGROUND OF THE INEVENTION

1. Field of the Invention

The present invention relates to a reduction in power consumption in the idle state of a mobile telephone device having high frequency synchronizing clock and low frequency synchronizing clock.

2. Description of the Related Art

A mobile telephone device is a battery-driven electronic communication device which contains battery within the body and supplies operating power necessary for the electronic circuits.

In the field of the mobile telephone device, the second generation mobile telephone as represented by the conventional PDC system is in the process of moving to the third generation mobile telephone as represented by the W-CDMA system.

Different from the second generation telephone which guarantees simultaneous connectivity by dividing frequencies allocated to communication common carriers into fixed channels and sharing one channel by time, the third generation mobile telephone employs a code-division multiple-access system which communicates using, as one channel, a wide frequency band spread by spreading codes in order to be more multiplexed. The third generation mobile telephone also employs a RAKE receiver constituted by a multi-finger receiver to prevent the communication quality from getting degraded by fading. This causes the third generation mobile telephone to consume much more power and shorten what is called waiting time than the second generation mobile telephone.

Generally, a typical mobile telephone device, when it receives an incoming call or a mail, notifies thereof to the operator of the device by a beeper or a vibrator, and displays information such as a telephone number of the calling side as well as such status as “You get an incoming call” on the assumption that the operator of the device will see the LCD nearer at hand. Recently, the mobile telephone has increased its built-in capabilities. It has installed not only communication capabilities but also mailer and scheduler capabilities using the LCD as a main interface and has loaded a JAVA virtual machine and a digital camera. (“JAVA” is a trademark of Sun Microsystems, Inc.) This causes the mobile telephone device to increasingly depend on the LCD, which requires more and more power by the display function, combined with the colorization of the LCD.

Usually, the LCD on the mobile telephone device uses the display memory dedicated to an LCD controller, and it has the configuration that no data is transferred to the LCD until the display data is updated. However, such configuration causes the overall memory capacity to become larger and pushes up the cost, so recently, the technique has been taken that the CPU shares a directly accessible memory with the LCD without placing the memory on the LCD. In this case, the data is transferred from the memory to the LCD via the LCD controller at regular intervals. In the mobile telephone device in which the time to leave it unattached is by far longer than the time to use it actually, it is extremely disadvantageous in power consumption to drive a bus with a much higher-speed system clock than the clock for driving LCD when it is left unattached.

Unlike the electronic equipment such as portable game machines in which the power is cut when unused, the mobile telephone device stands by for an incoming call from others. Accordingly, the power is on even when it is unused. Also, unlike a car navigation system, the mobile telephone cannot depend on external power, so the problem of power consumption is all the more serious, compared with other devices.

In order to meet these demands, a variety of solutions have been suggested. For example, in the folding mobile telephone device, one cannot see the LCD in the case-folded state, so it is more common to reduce the chance to display in such a way that it is not until the case is opened that power is supplied to the LCD and the display of the LCD gets under way.

Japan Tokkai Publication No. 2001-345928 discloses a method for reducing the amount of data transfer to the LCD and the display memory by controlling the levels of gray scale.

Furthermore, the LCD, having memories on both the LCD and the CPU, has been proposed in which memory on the CPU side are used as the display memory when high speed display is necessary, and the memory on the LCD side is used when high speed display is not necessary.

However, the on/off state of the display screen by closing or opening of the case has little room for diversion except for a folding mobile telephone device whose physical form is used as a switch. It is applied only to a slide type mobile telephone.

The method disclosed in the Tokkai Publication No. 2001-345298 has also a design defect, that is, a change in the levels of gray scale leads to more changes in software.

Furthermore, if memory is carried on both the LCD and CPU sides, double display memories are required, resulting in a rise in the product cost.

In addition, lowering only operating clock (video clock) of the LCD does not lead to a significant reduction in power consumption of the entire system.

### SUMMARY OF THE INVENTION

An object of the present invention is to provide a method for solving the above-mentioned problems and for lowering the cost and power consumption, regardless of the form of the frame.

A mobile telephone device according to the present invention comprises a CPU and a display controller which share a volatile memory via a bus, a fixed synchronizing signal and a variable synchronizing signal. The CPU operates in sync with the variable synchronizing signal. The display comprises a display controller and operates in sync with the fixed synchronizing signal. By being out of sync with both fixed and variable synchronizing signals, periodical access by the display controller to the volatile memory can stably be gained.

Preferably, the display controller for use in the present invention does not have a volatile memory for storing the display data, which is stored in the shared volatile memory.

It is preferred that the variable synchronizing signal used in the present invention lowers frequency when there is no operation by the operator of the device or no call-in for a certain period of time, and change from low frequency to high frequency when the operator operates the device or there is call-in in the low frequency state.

Moreover, it is preferable that the display controller in accordance with the present invention voluntarily reads data out of the volatile memory elements at certain intervals.

Of an illumination means for illuminating the display and an illumination control means for controlling the illumination means in accordance with the present invention, the illumination control means preferably includes a means for putting the illumination means out after a given period of time.

A method of controlling display images of a mobile telephone device in accordance with the present invention comprises: a normal processing step of performing application processing; an image display step of refreshing the image display; an input supervisory step of determining the presence or absence of an external input; a variable synchronizing signal adjusting step of changing variable synchronizing signal which functions as a reference when the input supervisory step performs application processing of the external input; and an arbitration step of arbitrating which step should have priority for use on a bus if the normal processing step and the image display step conflict. The image display step performs the image display processing, using the display data stored in the volatile memory via the bus.

Preferably, the arbitration step might as well give priority on the image display step in execution even if the input supervisory step recognizes external inputs.

The arbitration step in accordance with the present invention preferably gives priority on the image display step in recognizing that the normal processing step in execution competes with the image display step.

The arbitration step in accordance with the present invention preferably gives priority on the image display step in recognizing that the image display step in execution competes with the normal processing step.

The variable synchronizing signal adjusting step in accordance with the present invention preferably slows down the variable synchronizing signal if the input supervisory step recognizes that there is no external input for a certain period of time when the variable synchronizing signal is at high speed, and speeds up the variable synchronizing signal if the input supervisory step recognizes an external input when the variable synchronizing signal is at low speed.

### BRIEF DESCRIPTION OF THE DRAWINGS

FIG. 1 is a block diagram illustrating the embodiment of a mobile radio device according to the present invention;

FIG. 2 is a block diagram illustrating the configuration of a timing generation circuit of the mobile radio device according to the present invention;

FIG. 3 is a circuit diagram illustrating an example of the concrete constitution of the timing generation circuit of the mobile radio device according to the present invention;

FIG. 4 is a flowchart showing migration to a power saving mode after turning on the mobile telephone device according to the present invention;

FIG. 5 is a flowchart showing migration to a normal mode after keying in a mode of power saving in the mobile telephone device according to the present invention;

FIG. 6 is a timing chart showing the input/output signals on the signal lines of the timing generation circuit when sending data to the display; and

FIG. 7 is a timing chart showing the input/output signals on the signal lines of the timing generation circuit when sending another horizontal line of data after having sent out one horizontal line of data to the display.

### DETAILED DESCRIPTION OF THE PREFERRED EMBODIMENTS

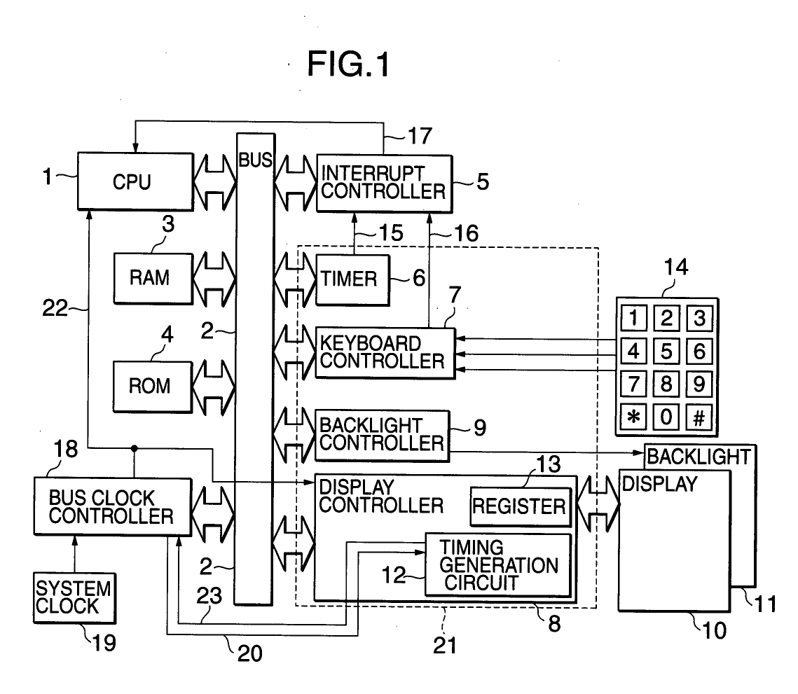

The embodiments of the present invention will be described in detail below with reference to FIGS. 1 through 3.

FIG. 1 is a block diagram of a mobile telephone device of a first embodiment according to the present invention. The invention is concerned with image display, so that a baseband section, a radio communication section and an antenna section which employ well-known circuitry are omitted for simplification in the drawings.

A CPU 1 reads programs stored in a ROM 4 via a bus 2 and controls an overall mobile telephone device using a RAM 3 as a work area. The CPU 1 also performs interrupt processing in response to an interrupt request signal notified through an interrupt signal line 17.

The bus 2 is a common interface for receiving and sending data between the CPU 1 and other modules and/or between modules. A module which takes control of the bus 2 (hereinafter referred to as a bus master) writes or reads data to or from a module to be accessed (hereinafter referred to as a slave) via the bus 2.

In this invention, the CPU 1 and a display controller 8 are capable of being a bus master. The bus 2 may either share the same bus signal lines or have individual signal lines for address and for data. The bus 2 also contains a clock signal line for a synchronizing clock which changes to a low speed depending on the status of the mobile telephone device for the purpose of a reduction in power consumption. The CPU 1 operates in sync with the synchronizing clock, and the technology for operation in response to a change in synchronizing clock is well-known in the art and is available for this invention. One of such examples is the technology of changing a synchronizing clock for CPU operation as employed in the “SpeedStep” technology of Intel Corporation, which is different in the field of industrial application from this invention. (“SpeedStep” is a trademark of Intel Corporation.) The synchronizing clock described herein is not supplied to all the modules. It is not fed to modules such as a timer 6 and the display controller 8, which malfunction by using variable synchronizing clock. The timer 6 and the display controller 8 operate with a peripheral clock. In the drawing, however, only a peripheral clock signal 20 fed to the display controller 8 is illustrated for simplification.

The RAM 3 is a volatile memory which serves as a work area for the CPU 1 and the display controller 8, and is utilized for temporary data storage for a CPU 1 work area. Generally, RAM 3 is not timed with a synchronizing clock in operation, and this invention also does not care whether RAM is synchronized or not. The ROM 4 is a memory which statically stores programs executed by the CPU 1. The ROM 4 may be replaced by a Flash ROM or an EPROM which is capable of maintaining data without a supply of power or with an extremely small supply of power. An interrupt controller 5 manages H/W interrupts from each device, and generates an interrupt request signal to the CPU1 when it receives a request of processing having priority over the processing in execution.

A timer 6 is a module which measures operating time of the mobile telephone device and performs timer operation for each processing by counting down the timer clock.

Unless otherwise specified in the embodiment of the present invention, the timer 6 is set to write a number to be decreased in the register before timer operation. When the number is counted down to zero, the timer 6generates an interrupt signal to the CPU 1 through the interrupt controller 5. The clock to be supplied to the timer 6 should be constant in order to calculate accurate time.

A keyboard controller 7 derives input data from the key entry of a keyboard 14, notifies an interrupt request to the CPU 1 via the interrupt controller 5 and provides the input data in response to the reading from the CPU 1.

The display controller 8 provides a display 10 with the peripheral clock, in sync with which the display 10 is refreshed. The display controller 8 also transfers the display data read out of the RAM 3 to the display 10. The display controller 8 controls the display 10 which operates in sync with the peripheral clock at a low speed, so that it operates using the low speed peripheral clock as is the case with the display 10. Thus, it is preferable that the clock to be supplied to the timer 6 is the peripheral clock.

A backlight controller 9 turns on and off a backlight 11 for illuminating the display 10. In many practical devices, the backlight is contained in the display controller 8. The on/off operation is performed setting a register in the backlight controller 9.

The display 10 shows the status of the mobile telephone device, in which a liquid crystal display (LCD) is generally used. The display 10 receives the low speed peripheral clock from the display controller 8 because the display 10 operates at low speed.

The backlight 11 illuminates the LCD of the display 10 and presents clear display information on the display 10 to an operator of the mobile telephone device. In this embodiment, the CPU 1 directly controls on/off operation by manipulating the register (not shown) in the backlight controller 9.

A timing generation circuit 12 in the display controller 8, using the peripheral clock, generates a page header signal 71, a vertical synchronizing (VSYNC) signal 72 and a horizontal synchronizing (HSYNC) signal 73 to the display 10, and feeds them to the display 10, and plays an intermediary as a mediator to transfer the display data sent from the RAM 3.

A register 13 in the display controller 8 is a register representing a transition period to a power saving mode, and the CPU 1 moves to the power saving mode referring to the register. Such a register is not necessary in employing Flash ROMs as the RAM 3 and ROM 4 since it is prerequisite that different from a personal computer, the mobile telephone device be steadily fed with power supply.

The keyboard 14 is one of user interfaces and provides an input such as telephone number entry.

The interrupt controller 5 receives a keyboard interrupt signal 15 and a timer interrupt signal 16 and transfers an interrupt signal to the CPU 1 via an interrupt controller output signal line 17 if the processing required by the interrupt signal has priority over the processing in execution.

A bus clock controller 18 not only controls the masters and slaves in accordance with the status thereof but also feeds the synchronizing clock to the modules such as the CPU 1 by raising frequency with a frequency multiplier. The bus clock controller 18 also has a function of a bus arbiter which arbitrates the occupancy of the bus 2 between the CPU 1 and the display controller 8.

A system clock 19 is a basic clock for synchronization when the mobile telephone device is in operation. In this embodiment, the system clock 19 has a crystal oscillator of a low frequency, which is then multiplied to generate a signal of a high frequency for a synchronizing clock in a normal mode, while in a mode of power saving, it changes the frequency of the synchronizing clock by lowering a multiplier factor. In addition, the system clock 19 is used as it is as the peripheral clock to operate the display 10. In the alternative, a crystal oscillator of a high frequency may be used and the high frequency may be frequency-divided to produce a peripheral clock of a low speed.

The peripheral clock appears on a peripheral clock signal line 20 and is supplied to the display 10. The display controller 8 generates a VSYNC signal and a HSYNC signal on the basis of the peripheral clock. Regardless of change in the synchronizing signal, the peripheral clock remains unchanged and is usable as a clock for timer the timer 6.

A peripheral controller 21 is a generic name for the timer 6, the keyboard controller 7, the display controller 8 and the backlight controller 9. These modules are represented collectively by a peripheral controller as long as there is no need for individual descriptions.

A bus busy signal line 22 carries, to a module capable of being a bus master, a bus busy signal indicative of whether or not the bus 2 is busy. In this embodiment, the bus busy signal 22 is electrically connected to the CPU 1 and the display controller 8.

By way of example, instead of the register 13 in the display controller 8, the content of the register may be written in the RAM 3 or statically stored in the ROM 4.

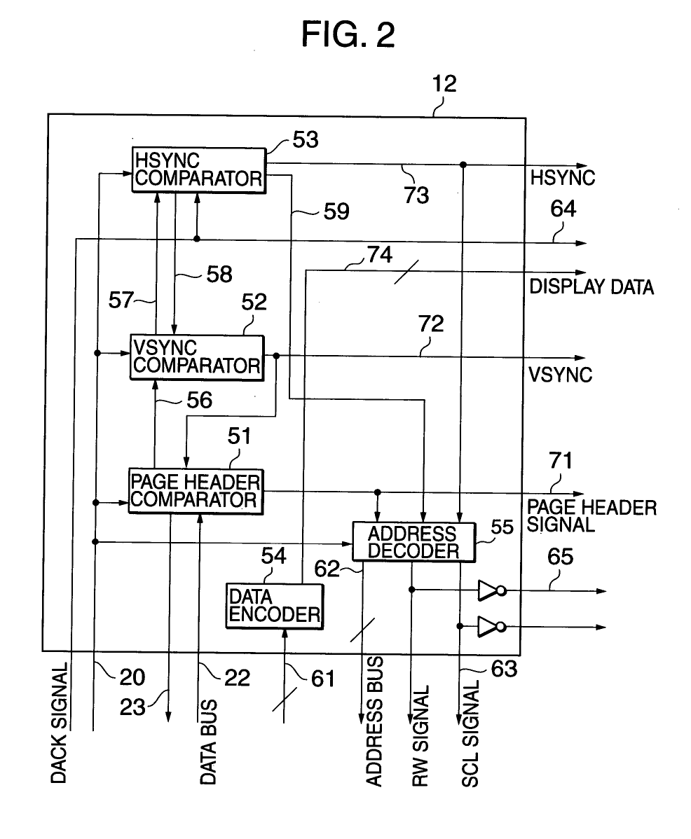

Referring to FIG. 2, the configuration of the timing generation circuit 12 in the display controller 8 will be described. The timing generation circuit 12 operates with the peripheral clock of a low speed, similarly with the display 10.

A page header comparator 51 is an internal module determining the initiation of the processing by the timing generation circuit 12 and is electrically connected to a peripheral clock signal line 20 and the bus busy signal line 22. A page header signal line 71 is coupled to the display 10, and a VSYNC mask signal line 56 is connected to a VSYNC comparator 52.

The page header comparator 51 counts the peripheral clock 20 and outputs a page header signal on the page header signal line 71 for each elapse of a predetermined time to renew or refresh the display image on the display, and also outputs the VSYNC mask signal on the VSYNC mask signal line 56 at the trailing edge of the page header signal. The VSYNC mask signal is reset at the trailing edge of the VSYNC signal provided by the VSYNC comparator 52.

The VSYNC comparator 52 is an internal module which outputs a vertical synchronizing signal (VSYNC signal) for every line of the display 10 and synchronously operates with the peripheral clock. The VSYNC mask signal line 56 is connected to the page header comparator 51 while a HSYNC mask signal line 57 is coupled to a HSYNC comparator 53.

When the VSYNC mask signal line 56 is active, the VSYNC comparator 52 supplies the VSYNC signal to the display 10 and the page header comparator 51 via a VSYNC signal line 72. At the trailing edge of the VSYNC signal, the VSYNC comparator 52 outputs the HSYNC mask signal through the HSYNC mask signal line 57.

The HSYNC comparator 53 is an internal module which outputs a horizontal synchronizing signal for every dot on the display. The module also operates synchronously with the peripheral clock 20. The HSYNC comparator 53 receives the HSYNC mask signal from the VSYNC comparator 52 via the HSYNC line 57, outputs the HSYNC signal via the line 73 to the display 10 and an address decoder 55, and outputs a HSYNC mask reset signal via a line 58 to the VSYNC comparator 52. The HSYNC comparator 53 contains a counter to count the number of HSYNC signal pulses.

When the HSYNC mask signal line 57 is active, the HSYNC comparator 53 outputs the HSYNC signal via the line 73 to the display 10 and the address decoder 55. The HSYNC comparator 53, which continually outputs the HSYNC signal, is different from the VSYNC comparator 52 in that it is not until the counter in the comparator 53 counts up a predetermined number (the number of dots for a horizontal scanning line of the display 10) that the comparator 53 outputs the HSYNC mask signal via the HSYNC mask reset signal line 58 to reset the HSYNC mask signal.

A data encoder 54 is a module which transforms the value on the data bus fed from the memory to a form readable from the display 10. In the first embodiment of the present invention, the data in the RAM 3 is assumed to be stored in such a form that the data can be sent to the display 10 as it is, so data conversion is not made in the module.

The address decoder 55 counts the pulses of the HSYNC signal from the HSYNC comparator 53, and based on the count of the counter, determines and sets the address for the bus 2. The page header comparator 51 and the HSYNC comparator 53 is connected to the address decoder 55 via the page header signal line 71 and via the HSYNC signal line 73, respectively. The address decoder 55 outputs address, an SCL signal and a read/write(R/W) signal on the bus 62, an SCL signal line 63 and a read/write(R/W) signal line 65, respectively.

The address decoder 55 prepares to output the address on an address bus 62 at the leading edge of the page header signal, and sets the address thereon at the leading edge of each pulse of the HSYNC signal. Coupling the HSYNC signal through an inverter, the address decoder 55 outputs the SCL signal on the SCL signal line 63 as a timing signal for memory access.

As long as the VSYNC mask signal line 56 is active, the VSYNC comparator 51 is allowed to output the VSYNC signal. The signal line becomes active at the trailing edge of the page header signal.

When the HSYNC mask signal line 57 is active, the HSYNC comparator 53 is allowed to output the HSYNC signal. The line 57 is activated at the trailing edge of the VSYNC signal.

The HSYNC mask reset signal line 58 conveys a signal output when the HSYNC signal generates the pulses over an entire horizontal line. In case that the HSYNC signal is provided for the entire picture elements of the picture frame, the HSYNC mask reset signal does not appear and an internal reset signal 9 is outputted.

The internal reset signal 59 is a line for a signal which initializes the address decoder 55 when all the processing is completed for the page header signal. Principally, the line 59 may be dispensed with, while it is provided to prevent malfunctioning of the address decoder.

A data bus 61 is a group of signal lines in the bus 2 for conveying data signal, which in this embodiment, passes through the data encoder 54 to the display without conversion.

The address bus 62 is a group of signal lines in the bus 2 for conveying address signal, which is set to access the RAM 3 at the leading edge of the HSYNC signal.

The SCL signal 63, when active, notifies the slave to prepare data, based on the address set on the address bus 62. Although it looks apparently like an inversion of a HSYNC signal 73, the SCL signal 63 is not the simple inversion in a strict sense because it is not outputted until the address bus 62 is set.

A DACK signal line 64 is a line whose signal represents the R/W timing of data issued by slaves and which is ordinary stabilized at high level. The master is notified the slave of the setting of the address to be read by making the SCL line at low level. On completion of the setting of the data bus 61, the slave generates a low pulse signal on the DACK signal line 64, at the trailing edge of which the bus master reads the data on the bus 61.

The R/W signal line 65 is a signal line on which the R/W signal indicating read/write operation to the slave appears. In this embodiment, the read operation is made on the bus at high level, while the write operation at low level. The R/W signal is also conveyed to the display 10 after inversion by an inverter.

The page header signal (or the header signal line) 71 is a line to send the page header signal representing the head of the image to be refreshed. The header signal line 71 is connected not only to the display 10 but also to the address decoder 55 to send the page header signal as a signal indicative of the initiation of address conversion.

The VSYNC signal line 72 is a line to send to the display 10 the VSYNC signal indicating the head of data transmission for a horizontal line, and is also connected to the page header comparator 51 to reset the VSYNC mask signal with the output of the VSYNC signal.

The HSYNC signal line 73 is a line to convey the HSYNC signal to the display 10 to indicate the read timing of data dot by dot. The HSYNC signal line 73 is also connected to the address decoder 55 to change the value to be outputted on the address bus 62.

A display data bus 74 is a group of lines to which the data encoder 54 outputs the results obtained by encoding the data on the data bus 61 contained in the bus 2. In this embodiment, the content of data on the data bus 61 is outputted to the display data bus 74 as it is because code conversion is not made.

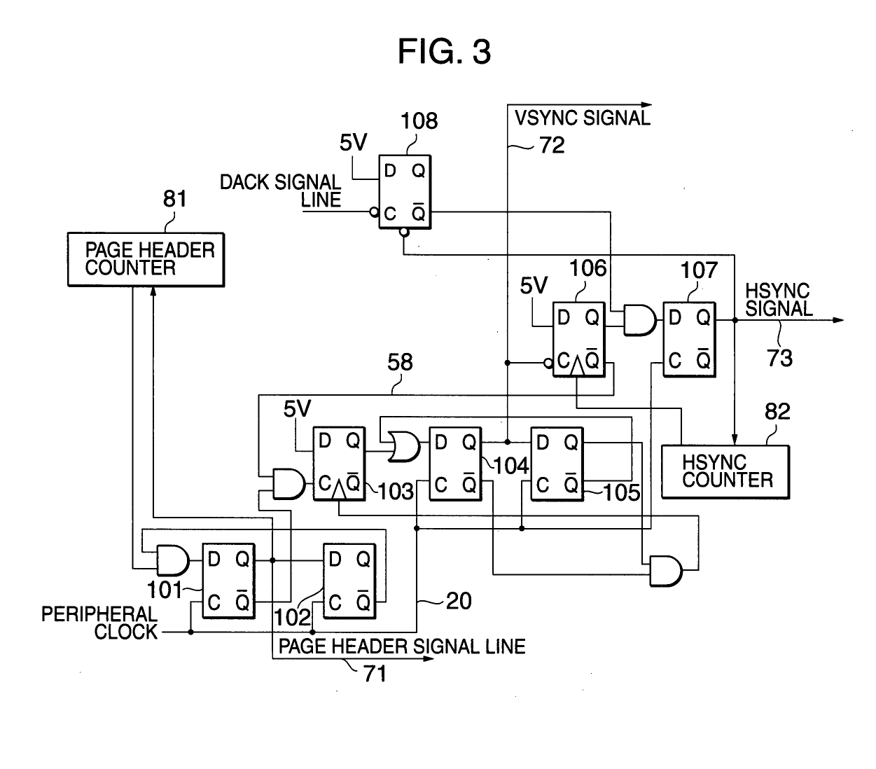

FIG. 3 illustrates a specific configuration of the page header comparator 51, the VSYNC comparator 52 and the HSYNC comparator 53 in the timing generation circuit 12. The circuit 12 mainly includes a first page-header-comparator flip-flop 101, a second page-header-comparator flip-flop 102, a first VSYNC-comparator flip-flop 103, a second VSYNC-comparator flip-flop 104, a third VSYNC-comparator flip-flop 105, a first HSYNC-comparator flip-flop 106, a second HSYNC-comparator flip-flop 107, a third HSYNC-comparator flip-flop 108, a page header counter 81 and an HSYNC counter 82.

A timer (not shown) in the page header counter 81 works to set the data terminal of the first page-header-comparator flip-flop 101 at high level in a predetermined period and then the uninverted output terminal of the flip flop 101 is set at high level at the time of the positive-going transition of the peripheral clock. The uninverted output terminal of the first page-header-comparator flip-flop 101 is connected to the page header signal line 71 as well as a line to convey a signal to reset the timer in the page header counter 81.

The uninverted output terminal of the first page-header-comparator flip-flop 101 is also coupled to the data terminal of the second page-header comparator flip-flop 102. Like the first page-header-comparator flip-flop 101, the second page-header-comparator flip-flop 102 is clocked synchronously with the peripheral clock and is set at high level at the positive-going transition of the peripheral clock immediately after the uninverted output terminal of the first page-header comparator flip-flop 101 is set at high level.

The logical level of the inverted output terminal of the second page-header-comparator flip-flop 102 is set at low level. The AND operation is performed with the logical level of the inverted output terminal and the output of the timer in the first page-header-comparator flip-flop 1, rendering the input of the first page-head-comparator flip-flop 101 at low level. The uninverted output terminal of the first page-header-comparator flip-flop 101 is set at low level at the time of the positive-going transition of the peripheral clock during the next cycle and generates a pulse in the page header signal. Thus, the time for the timer in the page header comparator 51 to be reset is secured to some extent, resulting in increase in design flexibility.

The data terminal of the first VSYNC-comparator flip-flop 103 is pulled up at high level and the inverted output terminal of the first page-header-comparator flip-flop 101, which is at high level in a normal state, is set at low level at the time of output of the page header signal. An AND gate performs the AND operation between the output of the inverted terminal of the first page-header-comparator flip-flop 101 and the output of the inverted terminal of the first HSYNC-comparator flip-flop 106, producing clock pulses for the first VSYNC-comparator flip-flop 103.

The reason for the AND operation with the output of the inverted output terminal of the first HSYNC-comparator flip-flop 106 is to set the output terminal of the first VSYNC-comparator flip-flop 103 to high level at the time of the negative-going transition of the output at the output terminal of the first HSYNC-comparator flip-flop 106 immediately after the HSYNC signal is fed to the display 10 for an entire horizontal line.

The inverted output terminals of both the first page-header-comparator flip-flop 101 and the first HSYNC-comparator flip-flop 106 are ordinarily stabilized at high level, and a pulse of low level occurs everytime an event is issued. The occurrence of the signal on either of the two signal lines sets the uninverted output terminal of the first VSYNC-comparator flip-flop 103 at high level at the leading edge thereof.

An AND gate performs the AND operation with signals appearing at the uninverted output terminal of the first VSYNC-comparator flip-flop 103 and at the inverted terminal of the third VSYNC-comparator flip-flop 105, and the output of the AND gate goes to the data terminal of the second VSYNC-comparator flip-flop 104. The uninverted output terminal of the second VSYNC-comparator flip-flop 104, which is in sync with the peripheral clock, is set at high level at the leading edge of the peripheral clock pulse immediately after the date terminal thereof turns to the high level.

The uninverted terminal of the second VSYNC-comparator flip-flop 104 is connected to the data terminal of the third VSYNC-comparator flip-flop 105 which is in sync with the peripheral clock. The high level at the data terminal of the third VSYNC-comparator flip-flop 105 sets the uninverted output terminal of the third VSYNC-comparator flip-flop 103 at high level with the time of occurrence of the positive-going transition of the peripheral clock. The AND operation is performed at an AND gate with the output of the uninverted output terminal of the third VSYNC-comparator flip-flop 105 and the output of the inverted output terminal of the second VSYNC-comparator flip-flop 104. The result of the AND operation is led to the reset terminal of the first VSYNC-comparator flip-flop 103. Thus, the first VSYNC-comparator flip-flop 103 is reset at the trailing edge of the high level signal which appears at the output of the AND gate when both the uninverted terminal of the third VSYNC-comparator flip-flop 105 and the inverted terminal of the second VSYNC-comparator flip-flop 104 go to high level.

The uninverted terminal of the second VSYNC-comparator flip-flop 104 is connected to the display 10 through the VSYNC signal line 72 and is also led to the clock terminal of the first HSYNC-comparator flip-flop 106 through an inverter. As the data terminal of the first HSYNC-comparator flip-flop 106 is maintained at high level, the uninverted output terminal of the first HSYNC-comparator flip-flop 106 is set at high level at the time of occurrence of negative-going transition of the signal appearing at the uninverted terminal of the second VSYNC-comparator flip-flop 104. The uninverted output terminal of the first HSYNC-comparator flip-flop 106 is connected to the data terminal of the second HSYNC-comparator flip-flop 107 through an AND gate with the inverted terminal of the third HSYNC-comparator flip-flop 108.

The second HSYNC-comparator flip-flop 107 is clocked with the peripheral clock and is set to generate a pulse of high level at the uninverted terminal thereof at the time of occurrence of the positive-going transition of the next peripheral clock. The uninverted output terminal of the second HSYNC-comparator flip-flop 107 is connected to the display 10 via the HSYNC signal line 73.

The third HSYNC-comparator flip-flop 108 is connected, at the reset terminal, to the HSYNC signal line 73 via an inverter, and at the clock terminal, to the DACK signal line 64 from the bus, and at the data terminal, to a constant voltage source. The inverted terminal of the flip-flop 108 is connected through the AND gate to the data terminal of the second HSYNC-comparator flip-flop 107 and the uninverted output terminal of the first HSYNC-comparator flip-flop 106.

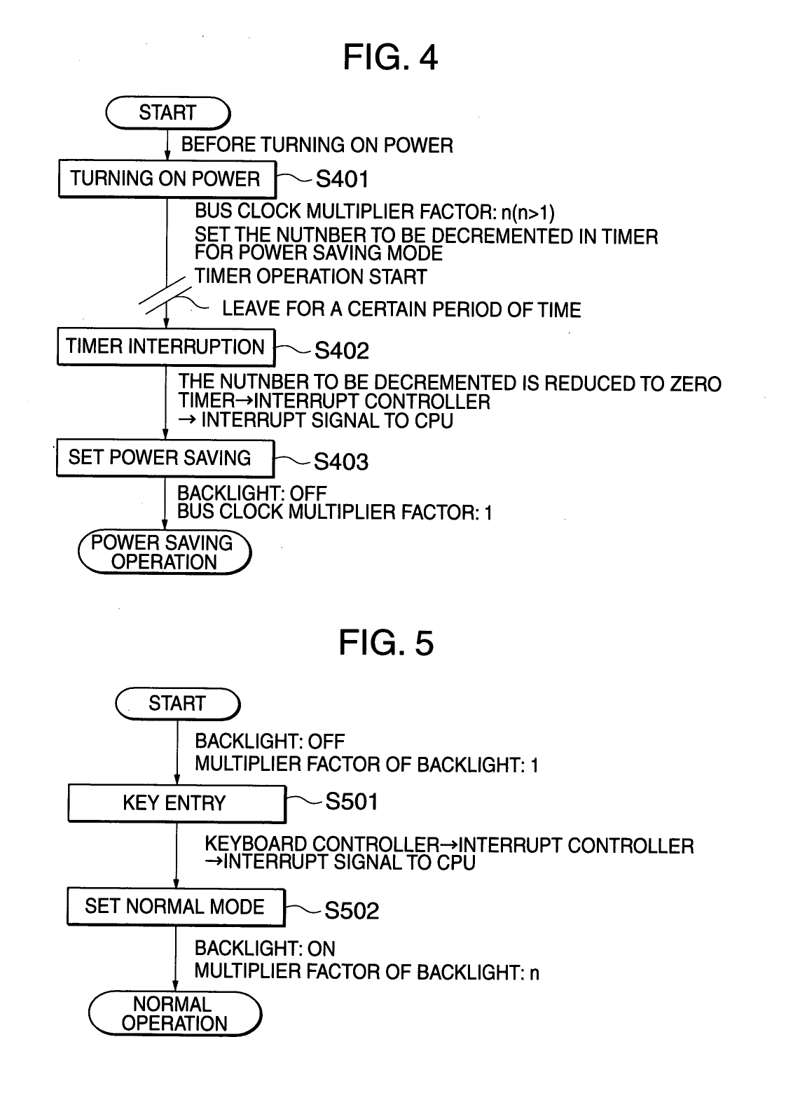

Next, actual operation will be explained with reference to FIGS. 4 and 5.

FIG. 4 is a flowchart showing the processes of the present invention viewed from the outside that the mobile telephone device goes into a power saving mode after an operator turns on the power supply and leaves it as it is for a certain period of time.

When the operator turns on the power (at step 401), the mobile telephone device is activated. The activation process comprises not only the reading of programs out of the ROM 4, the refreshing of the RAM 3, the initializing of the interrupt controller 5 and the timer 6 but also in connection with the display 10, the reading of “a number to be decremented” representing a time to go into the power saving mode out of the bus clock controller 18 and the writing of a multiplier factor “n” into the register 13. In this case, if “n” is an integer equal to or greater than 2, a designer of the device may choose any number. As for the operation of the baseband section and the radio section (both not shown), the operating clock should be fixed with respect to communication protocols.

After an elapse of a predetermined time, the timer 6 is reduced to zero from the number written therein, generating timer interruption, on the basis of which the interruption controller 5 produces an interrupt signal to the CPU 1 (at step 402). In response to the interrupt signal, the CPU 1 inquires of the interruption controller 5 what the request is and recognizes that the timer 6 has issued the request, which indicates a transition to a power saving mode.

On detection of the transition to the power saving mode, the CPU 1 instructs the backlight controller 9 to turn off the backlight 11, which then goes off. Then, the CPU 1 sends a command to lower the synchronizing clock for the bus 2 to the bus clock controller 18 (at step 403). On receipt of the command, the bus clock controller 18 gradually lowers the multiplier factor “n” to “1”.

If the display controller 8 has access to the RAM 4 via the bus 2, the CPU 1 can change the synchronizing clock for the bus 2 without disturbing the reading to the display and flickering on the screen by awaiting the completion of the processing under way and upgrading the processing of the display controller 8 to the highest priority so that the CPU 1 can access the bus clock controller 8.

On completion of the transition, the synchronizing clock for the bus 2 changes to the frequency of the system clock 19, which is equal to that of the peripheral clock, and then the bus 2 is operated at low speed.

In the embodiment of the present invention, the system clock 19 provides the CPU 1 with the synchronizing clock by multiplying the frequency of the clock within a range of “n” to “1”. If the synchronizing clock for the bus 2 is supplied to the CPU 1 and the RAM 3 when the factor has fallen, higher power saving is effected because of a fall in the synchronizing clock in the overall system.

FIG. 4 illustrates the actions after turning on the power of the mobile telephone device. In leaving the device idle after completing the speech or emailing, the actions at and after step 402 may follow the action at step 401 by inputting the number to be decremented, which represents the transition into the power saving mode, to the timer 6. This design achieves further power saving.

On the other hand, FIG. 5 is a flow chart illustrating the processes from the power saving mode to the normal mode.

While the backlight 11 is in the off state and the synchronizing clock for the bus 2 is operating in the power saving mode with the multiplier factor “1” to the system clock 19, the keyboard controller 7, in response to the operator's key input to the keyboard, generates an interrupt request to the CPU 1 through the interruption controller 5 (at step 501).

On receipt of the interrupt signal, the CPU 1 confirms the content of the interruption processing to the interruption controller 5 through the bus and is notified of the input from the keyboard 14. Prior to input processing from the keyboard, the CPU 1 confirms the operation mode, recognizes the low speed mode and sends a command to the bus controller 18 (at step 502), as is the case with FIG. 4.

In the change of mode, the bus clock controller 18 gradually raises the multiplier factor to “n” in the normal mode in order to return to the written multiplier factor “n”.

In FIG. 5, although user's key entry causes going back to the normal mode, it is also possible for an incoming call or an incoming email to return to the normal mode.

While in FIGS. 4 and 5, the description has been made that the command is sent in the change of the operation, it is also possible to change the multiplier factor by providing the bus clock controller 18 with a register, into which the multiplier factor is written.

In connection with FIGS. 4 and 5, a frequency multiplier circuit, a frequency divider circuit and a mechanism to change the multiplier factor is well known in the art, so the description of such circuits is left out. In changing a multiplier factor or a division factor, the design is simplified if there is no access to the bus 2. However, to secure the high speed operation of the mobile telephone device, the access to the bus 2 may be allowed by taking measures to prevent devices connected to the bus 2 from malfunctioning.

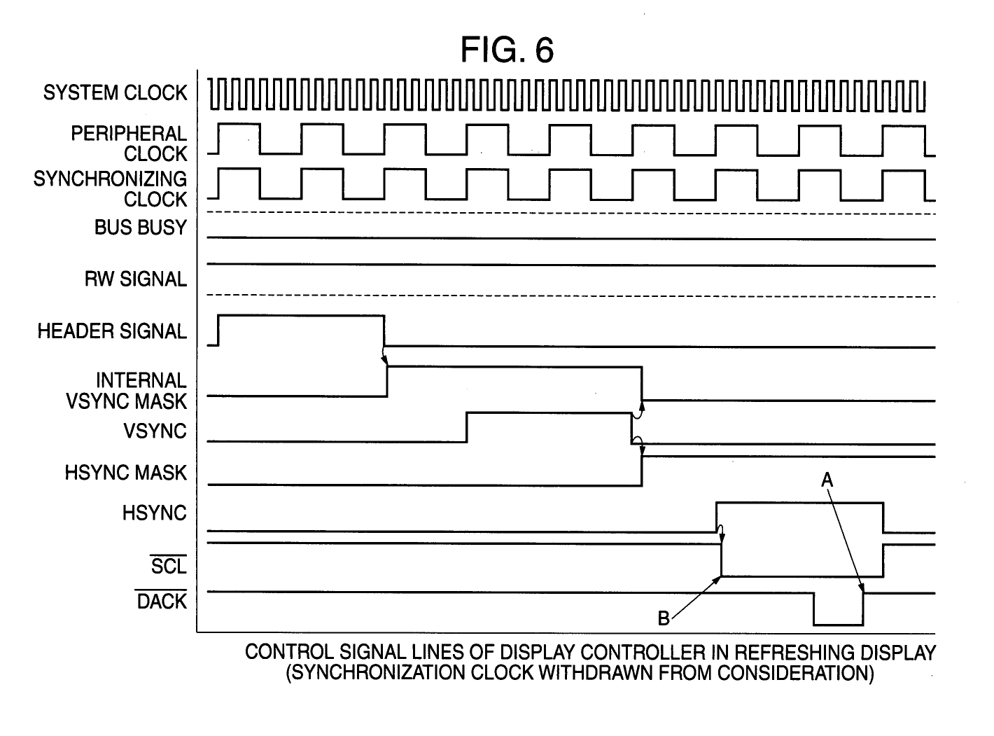

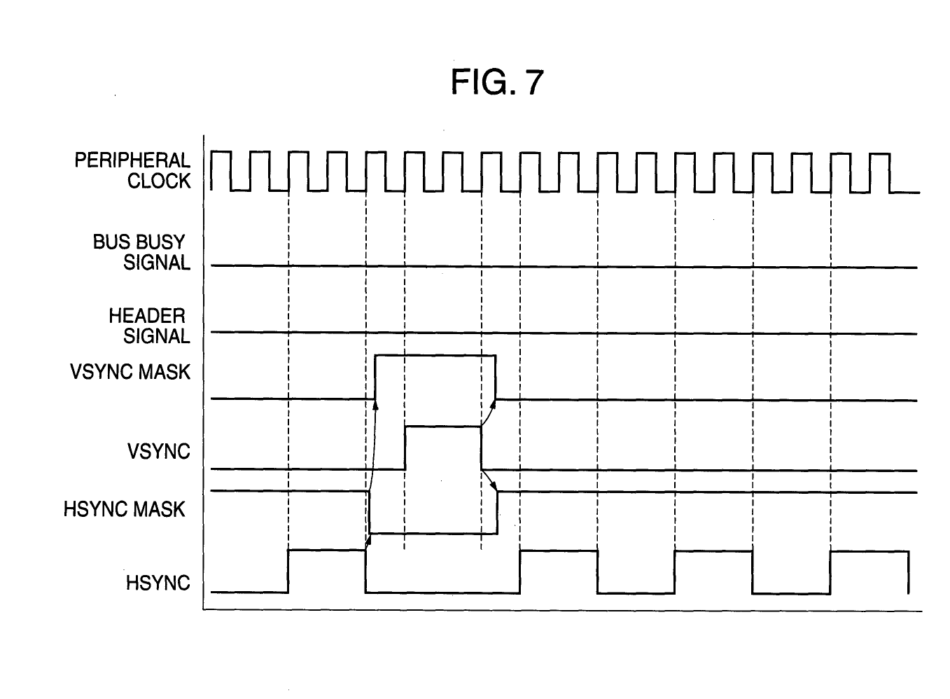

FIGS. 6 and 7 show timing charts of signals appearing on lines around the display controller 8 in this embodiment. In the timing charts, the synchronizing clock is equivalent to the peripheral clock, the system being in the power saving mode.

FIG. 6 is a timing chart in connection with the display 10 which is refreshed after a lapse of a predetermined period.

The address decoder 55 in the display controller 8 sets the R/W signal line 65 at high level when the bus busy signal line 22 is not occupied (the busy signal being low in the drawing). On this occasion, the address decoder 55 provides the display 10 with an inversion of the R/W signal through an inverter, instructing the display to initiate the reading of the data. In the drawing, the timing chart starts with such a state.

The page header comparator 51 notifies the display 10 of sending display data by outputting the header signal on the header signal line 71. This signal is fed to the uninverted terminal of the first page-header-comparator flip-flop 101 as shown in FIG. 3.

At the trailing edge of the header signal, the VSYNC mask signal (appearing at the uninverted output terminal of the first VSYNC-comparator flip-flop 103 in FIG. 3) is set at high level. After the high-level setting of the VSYNC mask signal, the VSYNC signal line 72 is set at high level at the time of the positive-going transition of the next peripheral clock pulse.

Two clock pulses behind the buildup of the VSYNC signal, the VSYNC signal falls down. The falling edge acts as a trigger not only to return the internal VSYNC mask signal to low level, but also to set the HSYNC mask signal (appearing at the uninverted terminal of the first HSYNC-comparator flip-flop 106) at high level.

At the time of the positive-going transition of the next synchronizing clock pulse immediately after the HSYNC mask signal is set at high level, the HSYNC signal 73 is outputted to the display 10 and the address decoder 55. The address decoder 55 sets the address on the address bus 62 at the trailing edge of the HSYNC signal pulse and then produces an inversion of the HSYNC signal on SCL signal line 63, notifying the RAM 3 connected to the bus 2 of the completion of the setting of the address bus 62. Therefore, it is preferable to mask the SCL signal 63 until the completion of the setting of the address bus 62. Based on the address, the RAM 3 sets the data on the data bus 61, generating a pulse signal on the DACK signal line 64. The pulse signal on the DACK signal line is set at the display 10 as it is, and at the leading edge of the pulse signal, the display 10 reads the data, setting the HSYNC signal at low level at the leading edge of the next peripheral clock pulse. These results are reflected on the SCL signal line 63.

FIG. 7 illustrates a timing chart with respect to outputting the next one line data to the display 10 after one line data for the display 10 is outputted.

At the trailing edge of the last pulse of the HSYNC signal 73 for one horizontal line, the HSYNC mask signal and VSYNC mask signal are set at low and high levels, respectively, resulting in the VSYNC signal appearing on the VSYNC signal line 72 at the leading edge of the next peripheral clock pulse. Similar operation takes place as explained in FIG. 6.

In accordance with the above-mentioned routine, the display controller 8 reads the data out of the RAM 3 and outputs the display data to the display 10. The display controller 8, i.e., a bus master, operates with a fixed peripheral clock, while the RAM 3, i.e., a slave, operates in an asynchronous mode. Thus, the stable operation can be achieved regardless of the state of the synchronizing clock. Lowering the speed of the synchronizing clock leads to power saving.

With a view to further power-saving by reducing a chance for the CPU 1 to access the bus 2, a second embodiment of the present invention is explained with reference to FIG. 1.

Generally, a backlight of the mobile telephone device is turned off after leaving it idle for a certain period of time. The backlight 11 in FIG. 1 is usually put off by setting the data at the register of the backlight controller 9.

The processing of putting off the backlight 11 in the above-mentioned mechanism is as follows: After starting the timer operation by setting the time for light-out and receiving an interrupt signal generated at the timer 6 in a predetermined time, the CPU 1 sets the data in the register of the backlight controller 9 to turn off the backlight 11.

However, such a mechanism has a disadvantage in power consumption because the CPU1 operates through the bus 2. Moreover, the mechanism has a problem in software design, accompanied by an increase in objects for interruption processing.

The disadvantage and the problem can be overcome by providing the backlight controller 9 with a dedicated timer and spontaneously turning off the backlight 11 on the completion of the count of the timer. Such a provision can lower power consumption because it reduces unnecessary interrupts to the CPU 1, which then causes the processing in execution to be saved. Particularly, in unused time, power consumption in the timer itself can be saved if the timer operation in the backlight controller 9 is deactivated by setting a mask and stopping the supply of the synchronizing clock. Furthermore, if the mask for the synchronizing clock is cleared at the same time that the instruction of turning on the backlight 11 is written in the register, it does not increase load on software.

Likewise, the saving of power consumption can be achieved by a reduction in the number of access to the bus in such a manner that a dedicated timer and an internal register indicating the enabling and disabling of the operation of the display 10 is provided for the display controller 8, and the operation of the display 10 is spontaneously stopped on completion of the count of the timer. As is the case with FIG. 5, in the resumption of display on the display 10, the CPU 1 has access to the internal register in the display controller 8 by means of the interrupt processing based on an incoming call or key entry, resulting in a return to the display state.

In the mobile telephone device according to the present invention, in which the synchronizing clock for the CPU 1 and the like is changed in speed depending on operation circumstances, a reduction in power consumption and a stable operation in display can be achieved in such a way that the CPU 1 shares the RAM with the display to prevent a great increase in cost, and the display is fed with a fixed clock with which the display is operated, while the RAM is not timed with a clock in operation.

Moreover, the provision of timers in the display and the backlight controller connected to the bus voluntarily stops the operation of the display and the backlight on completion of the count of a predetermined value in the timer without communicating with the CPU. As a result, the chance for the CPU to use the bus is reduced, resulting in saving in power consumption.

What is claimed is:

1. A mobile telephone device comprising:
a central processing unit;
a display controller;
a display; and
a volatile memory shared by said central processing unit and said display controller via a bus;
wherein said central processing unit operates in sync with a variable synchronizing signal; and
wherein said display and said display controller operate in sync with a fixed synchronizing signal.

2. The mobile telephone device in accordance with claim 1, wherein said display controller voluntarily reads data out of said volatile memory at regular intervals.

3. The mobile telephone device in accordance with claim 2, comprising:
illumination means switchable between on and off for illuminating said display; and
illumination control means for controlling said illumination means, said illumination control means including means for putting said illumination means out after a given period of time.

4. The mobile telephone device in accordance with claim 1, wherein said variable synchronizing signal is set at a lower frequency than a frequency in a normal operating state in the absence of operator's operation or call-in for a certain period of time, and is returned to the frequency in the normal operating state in response to operator's operation or call-in in the low frequency state.

5. The mobile telephone device in accordance with claim 4, wherein said display controller reads data out of said volatile memory in a predetermined cycle of time voluntarily.

6. The mobile telephone device in accordance with claim 5, comprising:
illumination means switchable between on and off for illuminating said display; and
illumination control means for controlling said illumination means, said control means including means for putting said illumination means out after a given period of time.

7. A method of controlling display images of a mobile telephone device, comprising:
a normal processing step of performing application processing;
an image display step of refreshing an image display;
an input supervisory step of determining the presence or absence of an external input;
a variable synchronizing signal adjusting step of changing a variable synchronizing signal which functions as a criterion when said input supervisory step performs application processing of an external input; and
an arbitration step of arbitrating the use of a bus on the basis of priority if said normal processing step and said image display step conflict;
wherein said image display step performs the image display processing via a bus, using the display data stored in a volatile memory via said bus.

8. The method of controlling display images in accordance with claim 7, wherein said arbitration step gives priority on said image display step in execution even if said input supervisory step recognizes an external input.

9. The method of controlling display images in accordance with claim 7, wherein said arbitration step gives priority on said image display step in recognizing that said normal processing step in execution competes with said image display step.

10. The method of controlling display images in accordance with claim 7, wherein said arbitration step gives priority on said image display step in recognizing that said image display step in execution competes with said normal processing step.

11. The method of controlling display images in accordance with claim 7, wherein said variable synchronizing signal adjusting step slows down said variable synchronizing signals if said input supervisory step recognizes that there is no external input for a certain period of time when the variable synchronizing signals are at high speed, and speeds up said variable synchronizing signals if said input supervisory step recognizes an external input when said synchronizing signal is at low speed.
